(19) United States
(12) Patent Application Publication
(10) Pub. No.: US 2016/0173669 A1
(43) Pub. Date: Jun. 16, 2016

(54) Smartphone cover with garment styling

(71) Applicant: Rachael Smiley, Fairfield, CA (US)

(72) Inventor: Rachael Smiley, Fairfield, CA (US)

(21) Appl. No.: 14/968,146

(22) Filed: Dec. 14, 2015

Related U.S. Application Data
(60) Provisional application No. 62/091,593, filed on Dec. 14, 2014.

(51) Int. Cl. H04M 1/02; H04B 1/3888

(52) U.S. Cl. CPC H04M 1/0283; H04B 1/3888

(57) ABSTRACT

A smartphone cover with garment styling provides the appearance of a tuxedo, a bridal gown, a cheerleader uniform, or some other distinctive garment, in the form of a three-dimensional simulation, without significantly increasing the overall thickness of the smartphone.

### CROSS-REFERENCE TO RELATED APPLICATIONS

This Application claims the benefit of U.S. Provisional Application No. 62/091593, filed Dec. 14, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to novelty items and in particular to a smartphone cover with garment styling. The two most predictable trends in consumer behavior are first, that the consumer desires a product which compares well with similar items owned by the consumer's peer group, and second, that the consumer desires a product which is distinctive from items purchased by the peer group: a product that is unique and expresses the consumer's individuality. This has led to the vast proliferation of various models and colors of cars, motorcycles, digital music players, laptop computers, and other salient consumer products. One way in which consumers distinguish their personal items from those of other people is the addition of one or more accessories to the personal item, such as a pair of fuzzy dice hanging from a vehicle's rear view mirror. The visual similarity of smartphones has led to a broad variety of covers in different colors, patterns, and materials, reflecting this purchasing trend. In light of this variety of smartphone covers, something that is completely new and different would be well received. A smartphone cover with garment styling, providing the appearance of a tuxedo, a bridal gown, a cheerleader uniform, or some other distinctive garment, would satisfy this demand.

### SUMMARY OF THE INVENTION

Accordingly, the invention is directed to a smartphone cover with garment styling. The cover provides the appearance of a tuxedo, a bridal gown, a cheerleader uniform, or some other distinctive garment, in the form of a three-dimensional simulation, without significantly increasing the overall thickness of the smartphone.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitutes a part of the specification. They illustrate one embodiment of the invention and, together with the description, serve to explain the principles of the invention.

FIG. 1 is a front view of the first exemplary embodiment, displaying the cover 10, the apertures 10A, and the smartphone 12.

FIG. 2 is a rear view of the first exemplary embodiment, displaying the cover 10, the apertures 10A, and the simulation 11.

FIG. 3 is a left side view of the first exemplary embodiment, displaying the cover 10, the apertures 10A, the simulation 11.

FIG. 4 is a right side view of the first exemplary embodiment, displaying the cover 10, the apertures 10A, and the simulation 11.

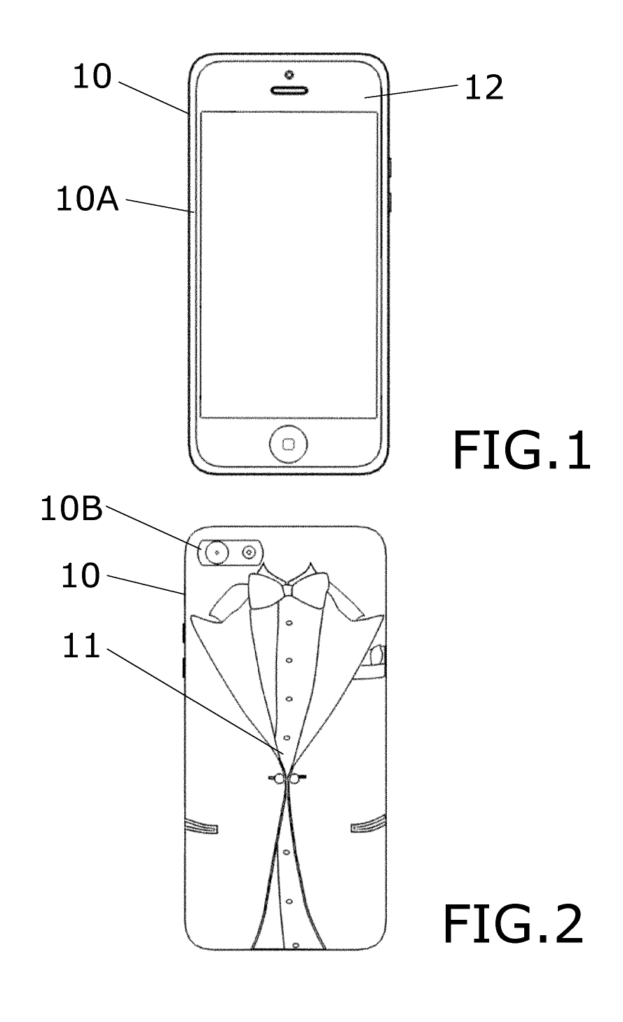

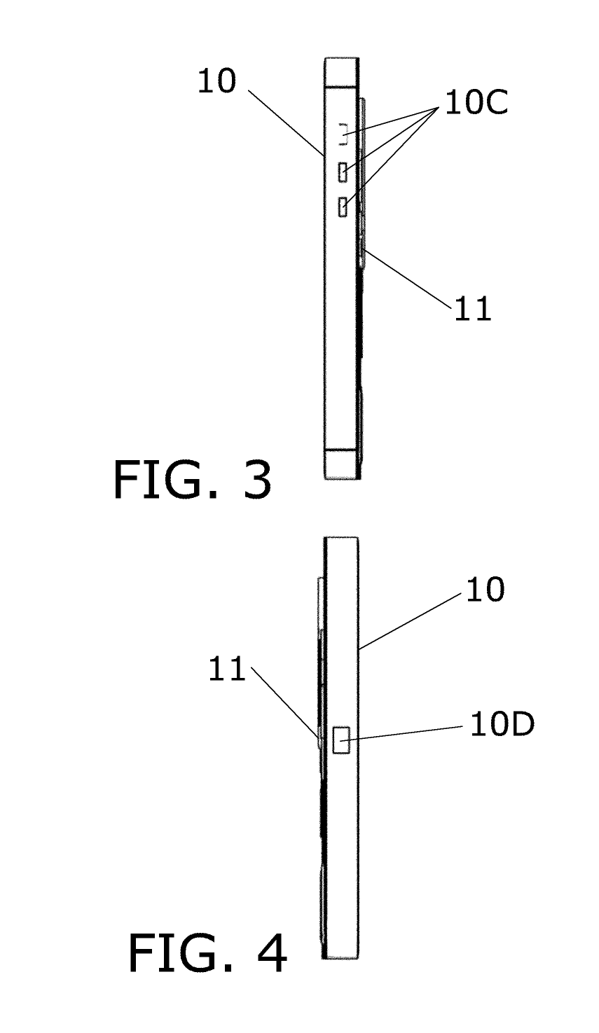

### DETAILED DESCRIPTION OF THE INVENTION

Referring now to the invention in more detail, the invention is directed to a smartphone cover 10 with garment styling.

It is to be understood that while the invention is intended for use with a smartphone, this is not intended as a limitation. With suitable modifications or with no modifications at all, the invention may be used with tablets, laptops, digital music players, and similar devices.

The first exemplary embodiment is comprised of a smartphone cover 10, which provides the appearance of a tuxedo, a bridal gown, a cheerleader uniform, or some other distinctive garment, in the form of a three-dimensional simulation 11 of the garment, principally on the rear surface of the cover 10. The simulation 11 is styled in much the same manner as doll clothing, but lays flat such that the cover 10 does not significantly increase the overall thickness of the smartphone 12.

The covers 10 are available with simulations 11 of a broad assortment of garments and garment accessories, such as a geisha girl's kimono and flowers, a bridegroom's tuxedo with a carnation on the lapel, a doctor's white coat and stethoscope, a hula dancer's grass skirt and flowers, and a police officer's uniform with badge, utility belt, walkie-talkie, sidearm, and baton. Simulations 11 may be available which represent various eras, such as a poodle skirt from the 1950s, a tie-dyed T-shirt and beads from the 1960s, or a disco outfit from the 1970s. The covers 10 are provided in various sizes to fit all smartphones, and provide a visual display aperture 10A, a camera aperture 10B, control apertures 10C, and a power input aperture 10D such that the user may easily access the visual display and controls of the smartphone 12, and use the camera feature of the smartphone 12.

To use the first exemplary embodiment, the user puts the cover 10 on the smartphone 12 such that the camera lens, controls, and visual display are accessible through the apertures 10A, 10B, 10C, and 10D of the cover 10.

The cover 10 is preferably manufactured from a rigid, durable material such as plastic, metal, or rubber. The simulation 11 is preferably manufactured from flexible, durable fabrics such as cotton, a cotton-rayon blend, or a cotton-polyester blend.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A mobile electronic cover with garment styling, comprising a mobile electronic cover and three-dimensional simulation; said three dimensional simulation being attached to a rear surface of said cover and having the appearance of a distinctive garment.

2. The mobile electronic cover with garment styling of claim 1 further comprising a plurality of apertures.

3. The mobile electronic cover with garment styling of claim 2 wherein one of said plurality of apertures is a visual display aperture.

4. The mobile electronic cover with garment styling of claim 2 wherein one of said plurality of apertures is a camera aperture.

5. The mobile electronic cover with garment styling of claim 2 wherein one or more of said plurality of apertures are phone control apertures.

6. The mobile electronic cover with garment styling of claim 2 wherein one of said plurality of apertures is a power input aperture.

7. The mobile electronic cover with garment styling of claim 1 wherein said three-dimensional simulation is styled in the same manner as doll clothing; said three-dimensional simulation lying flat against said rear surface of said cover.

8. The mobile electronic cover with garment styling of claim 1 wherein said mobile electronic cover is made of a rigid durable material such as plastic, metal, or rubber.

9. The mobile electronic cover with garment styling of claim 1 wherein said simulation is made from flexible durable fabric such as cotton, cotton-rayon blend, or cotton-polyester blend.

10. The mobile electronic cover with garment styling of claim 7 wherein said simulation is made from flexible durable fabric such as cotton, cotton-rayon blend, or cotton-polyester blend.
